(19) United States
(12) Patent Application Publication
(10) Pub. No.: US 2014/0122879 A1
(43) Pub. Date: May 1, 2014

(54) SECURE COMPUTING SYSTEM

(71) Applicants: Darren Cummings, Chandler, AZ (US); Richard Harding, Chandler, AZ (US)

(72) Inventors: Darren Cummings, Chandler, AZ (US); Richard Harding, Chandler, AZ (US)

(21) Appl. No.: 14/094,767

(22) Filed: Dec. 2, 2013

Related U.S. Application Data
(63) Continuation-in-part of application No. 13/413,959, filed on Mar. 7, 2012.

(51) Int. Cl. G06F 21/60

(52) U.S. Cl. CPC G06F 21/602
USPC 713/168; 726/34

(57) ABSTRACT

A secured computing system comprising a secure computing device capable of securing a host-computing device positioned nearby. The system further comprises a processing device, a battery charging circuit and a power measurement device, secured peripherals, radios such as 3G, 4G, Wi-Fi, Wi-Max, and LTE, a processing device to perform the required instructions and algorithms for configuring and performing security functions, processing device support components such as memory and co-processors to support the processing device. Finally, the system includes embedded software such as the source or executable files necessary to perform the instructions or algorithms to perform security functions.

### CROSS-REFERENCE TO RELATED APPLICATIONS

This application is a continuation-in-part to co-pending U.S. patent application Ser. No. 13/413,959 entitled “Secure Subjoined Computing Device” to Cummings et al., filed Mar. 7, 2012 which claims the benefit of U.S. Provisional Application Ser. No. 61/450,564 filed Mar. 8, 2011 and, all of which is incorporated herein by reference in their entirety.

### FIELD OF THE INVENTION

The present invention relates to the field of computer security, and, more particularly, to a secure computing device, system, and methods to provide enhanced security features for a host-computing device.

### BACKGROUND

According to recent studies, over two billion smartphones and tablet computers, commonly referred to as smart devices, are expected to ship globally starting this year. Yet despite the enormous popularity and wide range of applications available, such commercial mobile computing devices do not offer sufficient security features. At the same time, users feel comfortable with using the mobile devices that they have.

With more and more users of smartphones and tablets using the devices for more than communication tools security risks are increased. These smart devices collect and process significant amounts of sensitive information that make the smart devices more susceptible to malicious attacks. These malicious attacks attempt to exploit weaknesses that allow attackers to gain unauthorized access to the sensitive information. There are different security counter-measures available to cover the use of the devices such as hardware and software solutions.

This invention provides a novel solution for a secure computing system that includes a computing device able to accommodate a wide variety of host devices, commercial or proprietary, and provide an exclusive computing environment where strong authentication and encryption can be performed with or without the knowledge of the host device and host means to communicate the data from the device.

### BRIEF SUMMARY OF THE INVENTION

In one embodiment of the invention is a secured sub joined computing device comprising a sleeve capable of allowing a host-computing device to be positioned therein. Next, a processing device, integral with the sleeve, is adapted to allow communication with a host-computing device, when the host-computing device is positioned into the sleeve. Next a battery charging circuit and a power measurement device power the components of the sub joined computing device and provide auxiliary power for the host platform interface. Next, the system may include secured peripherals coupled to the sub joined computing device to enhance the input and output capabilities of the host-computing device such as secured memory, wireless connectivity to a network, and video capturing. Next the sub joined computing device may also include radios such as 3G, 4G, Wi-Fi, Wi-Max, and LTE. Next the sub joined computing device may also include a trusted platform module to safely store the cryptographic keys necessary to secure the components of the system. Next, the sub joined computing device may also include a processing device to perform the required instructions and algorithms for configuring and performing security functions. Finally, the sub joined computing device may also include processing device support components such as memory and co-processors to support the processing device.

In one embodiment of the invention is a system comprising a secure sub joined computing device. Next a host-computing device is coupled to the secure sub joined computing device via a host platform interface. Finally, the system includes embedded software such as the source or executable files necessary to perform the instructions or algorithms to perform security functions. The secure sub joined computing device is configured to perform security functions, such as data encryption and decryption, for the host-computing device.

One embodiment of the invention is a method operating on the sub joined computing device having physical memory comprising performing authentication management. Next, the method includes providing group and contact management such as real-time addition or revocation. Next, the method includes performing sanitization management. Next, the method includes providing data-in-transit protection such as peer-to-peer encryption and security. Next, the method includes ensuring data-at-rest protection and data-in-use protection. Next, the method includes providing seamless secure mobility management. Finally, the method includes providing an audit chain such as the end-user capability to define chain of custody.

In one embodiment of the invention is a secured computing system comprising a secure computing device capable securing a host-computing device positioned nearby. Next, a processing device, integral with the secure computing device, is adapted to allow communication with a host-computing device, when the host-computing device is positioned nearby the secure computing device. Next a battery charging circuit and a power measurement device power the components of the secure computing device and provide auxiliary power for the host-computing device. Next, the system may include secured peripherals coupled to the secure computing device to enhance the input and output capabilities of the host-computing device such as secured memory, wireless connectivity to a network, and video capturing. Next the secure computing device may also include radios such as 3G, 4G, Wi-Fi, Wi-Max, and LTE. Next the secure computing device may also include a trusted platform module to safely store the cryptographic keys necessary to secure the components of the system. Next, the secure computing device may also include a processing device to perform the required instructions and algorithms for configuring and performing security functions. Finally, the secure computing device may also include processing device support components such as memory and co-processors to support the processing device. Finally, the system includes embedded software such as the source or executable files necessary to perform the instructions or algorithms to perform security functions. The secure computing device is configured to perform security functions, such as data encryption and decryption, for the host-computing device.

One embodiment of the invention is a method operating on the secure computing device having physical memory comprising performing authentication management. Next, the method includes providing group and contact management such as real-time addition or revocation. Next, the method includes performing sanitization management. Next, the method includes providing data-in-transit protection such as peer-to-peer encryption and security. Next, the method includes ensuring data-at-rest protection and data-in-use protection. Next, the method includes providing seamless secure mobility management. Finally, the method includes providing an audit chain such as the end-user capability to define chain of custody.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a diagram of an exemplary embodiment illustrating a system to perform security functions for a host-computing device in accordance with the teachings of the present invention;

FIG. 2 is a diagram of an exemplary embodiment illustrating a secured sub joined computing device comprising a sleeve capable of allowing a host-computing device to be positioned therein to perform security functions for the host-computing device in accordance with the teachings of the present invention;

FIG. 3 is a diagram of an exemplary embodiment illustrating a system to perform security functions for a secure computing system in accordance with the teachings of the present invention;

FIG. 4 is a diagram of an exemplary embodiment illustrating a secured computing system comprising a secure computing device positioned in proximity to a host-computing device to perform security functions for the host-computing device in accordance with the teachings of the present invention.

### DETAILED DESCRIPTION OF THE INVENTION

According to a preferred embodiment of the present invention, a secure sub-joined computing device includes a sleeve capable of allowing a host-computing device to be positioned therein. Most preferably, the host-computing device is a computing device having a relatively thin profile, such as a tablet computer (e.g., Apple iPad) or a smart phone (e.g., Blackberry, iPhone, etc.). The exact dimensions of the sleeve will vary depending on the size of the particular host-computing device. Preferably, the sleeve itself will include a computing device, preferably, as an integral part of, or attachment to, the sleeve. Preferably, the sleeve will also include a communications (serial or parallel) interface adapter to allow communication between the secure sub-joined computing device and the host-computing device. Preferably, when the host-computing device is placed into the sleeve, the communications interface adapter connects with the communication port of the host-computing device. Additionally, preferably, the secure sub-joined computing device will include additional functionality, to include but not to be limited to input devices such as an authentication device (e.g., smart card reader or biometric device), cameras, microphones, etc. and could also include output devices, to include but not be limited to a printer, speaker, display, etc. The additional functionality can be contained or embedded in the sleeve or could be added as an inserted, separately constructed peripheral element. This element could also contain its own computing device and will communicate to the sleeve through a communication interface (serial or parallel). The peripheral element could be designed to be unique to the sleeve or designed to be interchangeable among any sleeve design. This would allow peripheral element function to be transferred freely from host-computing device to host-computing device. The peripheral element may, or may not, also contain a secure identification structure that would validate compatibility between the peripheral element and the sleeve. This would prevent the use of unauthorized peripheral elements to be inserted into the sleeve.

Preferably, the secure sub joined computing device will be able to accommodate a wide variety of host devices, commercial or proprietary, and provide an exclusive computing environment where strong authentication and encryption can be performed with or without the knowledge of the host device and host means to communicate the data from the device.

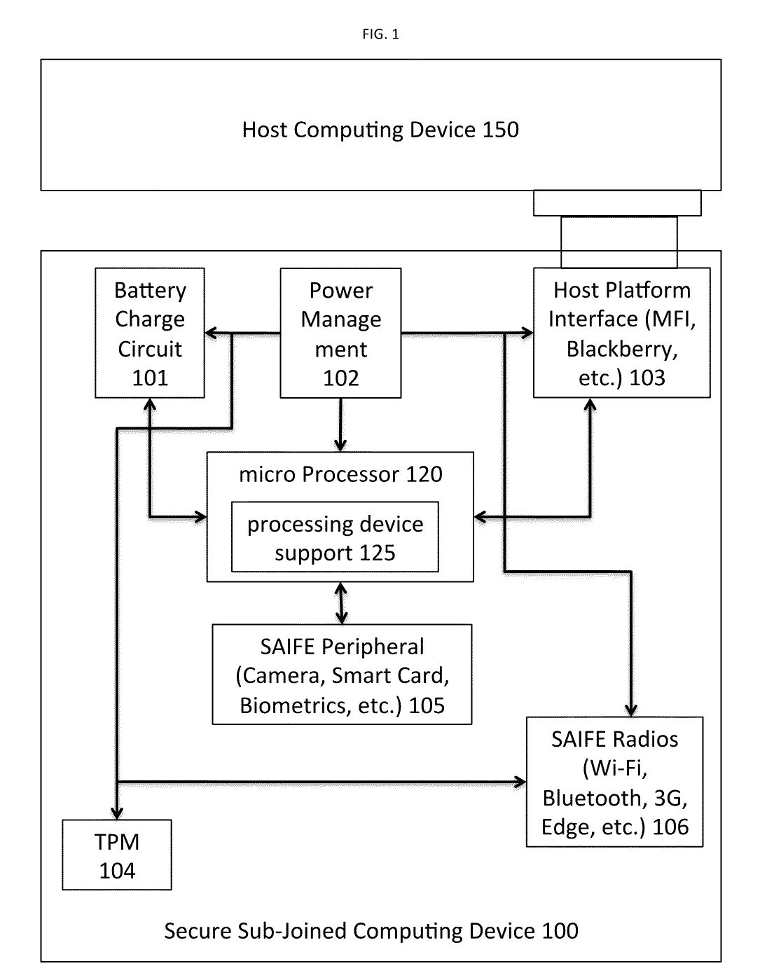

FIG. 1 illustrates an exemplary system of the present invention. As shown, a host-computing device 150 is coupled to a secure sub joined computing device 100 via a host platform interface 103. In the case where the host-computing device 150 is an Apple i-Pad, for example, the host platform interface 103 would be an “MFi” approved interface. In other cases, the host platform interface 103 could be a USB connection, for example. The connection between the host-computing device 150 and the secure sub joined computing device 100 may also be established via wireless networks. For example, the radios (e.g. Wi-Fi, Bluetooth, 3G, Edge, etc.) 106 may be used to couple the secure sub joined computing device 100 to the host-computing device 150. This allows the invention to work when a host-computing device 150 has a proprietary interface, or no external hardware interface at all. In this situation, the connection to the host-computing device 150 may be made over a wireless connection using a universal wireless standard such as Bluetooth or Wi-Fi as an alternative to a hardware connection. The secure sub joined computing device 100 may include multiple radios 106, or a radio capable of channel-switching, to connect with the host-computing device 150 and an external wireless network. The invention provides a ubiquitous solution allowing use of hardware or wireless connections, or both—including simultaneously or at separate instances. For example, a host-computing device 150 may be able to communicate to the sub joined computing device 100 via a hardware-based connection and at other times it may be advantageous for the connection to be established using the devices' radios via a wireless connection, or vice versa.

Also, as illustrated, the secure sub joined computing device 100 includes a power supply (battery charge circuit 101 and power management 102) to provide sufficient power to the components, as needed. In addition, auxiliary power could be supplied to the host-computing device 150 (though this is not shown). Additionally, as indicated, the secure sub joined computing device 100 can support a wide variety of peripherals (e.g., video camera, smart card, biometric reader, etc.) 105 and radios (e.g. Wi-Fi, Bluetooth, 3G, Edge, etc.) 106. Preferably, the secure sub joined computing device 100 could include a Trusted Platform Module (TPM) 104 to store the cryptographic keys used by the software of the invention. Preferably, each of the components of the secure sub joined computing device 100 described above includes embedded code that can be updated, most preferably via an external cable interface. This would provide a convenient method for provisioning the components based on the latest specifications.

At the heart of the secure sub joined computing device 100 is processing device (e.g., microprocessor, microcontroller, etc.) 120 and processing device support components (e.g., memory, clocking, etc.) 125, which includes the software of the invention stored therein. The software of the invention enables implementation of various security and cryptographic features, some of which are disclosed in co-pending U.S. patent application Ser. No. 12/916,535 entitled “Secure Communication System for Mobile Devices” to Jones et al., filed Oct. 30, 2010, and co-pending U.S. patent application Ser. No. 12/916,522, entitled “Technique for Bypassing an IP PBX” to Patel et al., filed Oct. 30, 2010, the contents of both of these applications incorporated herein by reference in their entirety. Such features include authentication management (including real-time ad hoc secure enclave management), group and contact management (including real-time addition/revocation), sanitization management (including rapid memory wiping), data-in-transit protection (including peer-to-peer encryption and security, “stealth” call set up techniques, no “man-in-the-middle” security, and key roll-over and related features), data-at-rest protection, data-in-use protection, seamless secure mobility management (including the ability to roam from one disparate network to another, while in secure mode, without losing crypto synch), and audit chain (including end-user capability to define chain of custody).

Notable advantages of the present invention include, without limitation, the ability to provide a mutually exclusive, independent computing environment whereby enhanced security can be offered without knowledge of the host device and the host-computing environment. Preferably, this invention allows a user to carry their security credentials with them in the secure sub joined computing device 100 independent of which host-computing device(s) 150 used such as environments where shared computing resources are found. Further, often commercial computing device manufacturers do not alter their devices to offer security to accommodate privileged data environments such as found in various environments such as medical community, financial community, defense and government communities, etc. This invention allows existing commercial devices to operate at a much higher level of protection than could be otherwise allowed on the host device.

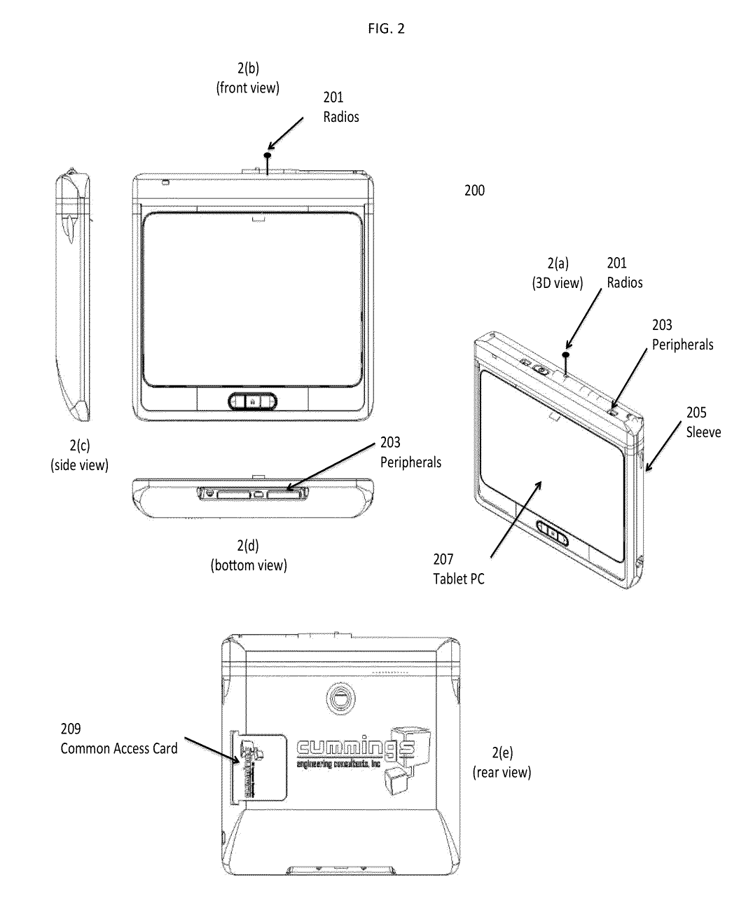

FIGS. 2(a) through 2(e) show various views of an exemplary system 200 including the secure sub joined computing device 100. As illustrated, the secure sub joined computing device 100 can accommodate a tablet PC. In this embodiment, the tablet PC can connect to 802.11g (minimum) WPA2-Enterprise wireless networks using an encryption module. Advantageously, the Wi-Fi radio in the sleeve can be used rather than the tablet's unsecured radio. While connected to the network via the secure sub joined computing device 100, the user can access PKI-controlled websites by using the currently inserted common access card (CAC) for authentication. The website will be displayed in a web browser application on the tablet PC. With CAC integration, the secure sub joined computing device 100 can use the inserted CAC card as a cryptographic ignition key, requiring a valid CAC with valid PIN or passcode to perform any encryption operations. The secure sub joined computing device 100 can store (data-at-rest) sensitive data in internal memory, protected with encryption. This data will be encrypted using the user's CAC card, and only be able to be decrypted when the CAC card is inserted and unlocked. Because the secure sub joined computing device 100 includes auxiliary batteries, using the secure sub joined computing device 100 provides additional battery life in addition to ruggedness. As constructed, the secure sub joined computing device 100 contains a modular electronics design, such that by making tradeoffs in the number of auxiliary batteries and additional weight, the secure sub joined computing device 100 can provide other data collection functionalities such as: (1) biometric enrollment/verification devices; (2) onboard cameras, permitting video recording or videoconferencing through the cryptographic module; (3) GPS antenna, with position information protected (enabling the “Geo-Spacial” features described hereinafter); and (4) additional radios, including options for tactical mesh IP, anti jam or beyond-line-of-sight communications, etc.

In addition to the features described above, the secure sub joined computing device 100 can also be configured to be limited to operate, or be prevented to operate, within a configured geographic boundary. Periodically, during operation, the device can determine its position using a position sensor (such as GPS, accelerometer, or a gyroscope) or by employing triangulation. After determining the position, a secure routine with the device can then determine if the device is geographically limited, and, if so, whether the device is within the limited area. If the device has been moved from the allowed area of operation, the routine can cause the device to be locked and refuse access, cause a panic data wipe of the device, or some other configurable function. This feature also provides the ability to dynamically provision a slow-moving or fixed surveillance asset to a contact list, permitting two-way trusted encrypted communication with the asset without requiring explicit per-instance configuration. This feature would additionally provide the ability to dynamically discover and provision other users who are using enabled communications devices offering the option to allow the end-user the ability to explicitly allow itself to be added to the secure group thus permitting two-way trusted encrypted communication.

By way of example, an encrypted IP security camera with remote control functionality is procured for a new mission. Before placement, the camera is provisioned into a secure enclave, and, furthermore it is registered with the Geolocation Service as a discoverable asset. The camera is placed in a strategic location with sufficient network bandwidth for its information payload. After placement, the camera periodically uses a built-in location device (e.g., GPS) to determine its physical location to its maximum precision. It also periodically downloads configuration data from the network. The downloaded configuration data contains parameters defining a geographical area relative to the camera's physical location. This geographical area can be defined as any two-dimensional field of points where point (0,0,0) is defined as the camera's location. Whenever the camera's physical location changes, the camera sends an encrypted geographical registration notification to the Geolocation Service containing a coarse-resolution physical location, provided by applying a mathematical rounding function to the precise location information. The level of obfuscation applied is contained within the configuration parameters. The registration notification sent by the camera also contains a coarse discovery radius, also a configurable value.

From the perspective of a mobile user, periodically or upon user-invocation the device will determine its physical location and send a coarse-resolution geographic discovery request to the Geolocation Service. The Geolocation Service will determine potential matches based on the coarse location of the mobile user and the coarse location of all registered discoverable assets and their discovery radii. The potential matches are then provided in response to the mobile user in the form of secure contacts. The mobile user device then can validate trust to each of the provided discoverable assets, and then either display discoverable assets as potential devices for the user to query at their leisure, or can automatically query each discoverable asset to determine whether it is valid for communication. Regardless of how the query begins, the mobile device sends an encrypted message to the discoverable asset through the network containing the device's high-precision location. The discoverable asset decrypts the message, validates the trust to the mobile device and then determines whether the mobile device's location is within the configured valid-location space. If the device is not within its valid space, the asset denies the query with an encrypted failure response. Otherwise, the asset responds with an encrypted access-granted notification. At this point the mobile device can set up an encrypted data session with the discoverable asset using the normal means to exchange data.

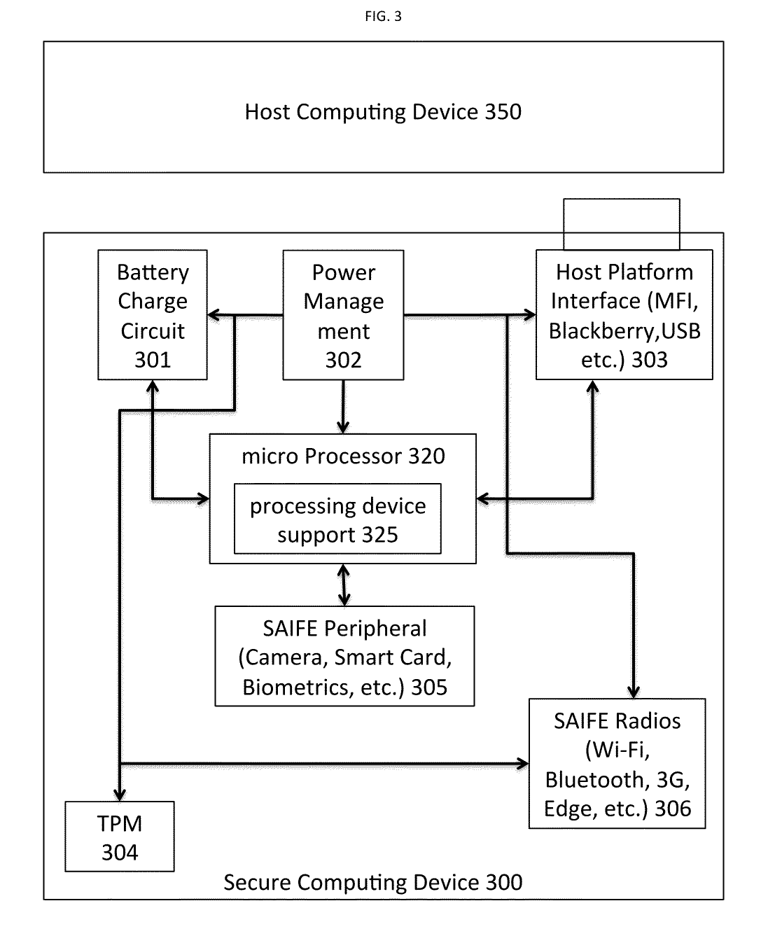

FIG. 3 illustrates an exemplary system of the present invention. As shown, a host-computing device 350 is coupled to a secure computing device 300 via a host platform interface 303. In the case where the host-computing device 350 is an Apple i-Pad, for example, the host platform interface 303 would be an “MFi” approved interface. In other cases, the host platform interface 303 could be a USB connection, for example. The connection between the host-computing device 350 and the secure computing device 300 may also be established via wireless networks. For example, the radios (e.g. Wi-Fi, Bluetooth, 3G, Edge, Near Field Communication, etc.) 306 may be used to couple the secure computing device 300 to the host-computing device 350. This allows the invention to work when a host-computing device 350 has a proprietary interface, or no external hardware interface at all. In this situation, the connection to the host-computing device 350 may be made over a wireless connection using a universal wireless standard such as Bluetooth or Wi-Fi as an alternative to a hardware connection. The secure computing device 300 may include multiple radios 306, or a radio capable of channel-switching, to connect with the host-computing device 350 and an external wireless network. The invention provides a ubiquitous solution allowing use of hardware or wireless connections, or both—including simultaneously or at separate instances. For example, a host-computing device 350 may be able to communicate to the secure computing device 300 via a hardware-based connection and at other times it may be advantageous for the connection to be established using the devices' radios via a wireless connection, or vice versa.

Also, as illustrated, the secure computing device 300 includes a power supply (battery charge circuit 301 and power management 302) to provide sufficient power to the components, as needed. In addition, auxiliary power could be supplied to the host-computing device 350 (though this is not shown). Additionally, as indicated, the secure computing device 300 can support a wide variety of peripherals (e.g., video camera, smart card, biometric reader, etc.) 305 and radios (e.g. Wi-Fi, Bluetooth, 3G, Edge, etc.) 306. Preferably, the secure computing device 300 could include a Trusted Platform Module (TPM) 304 to store the cryptographic keys used by the software of the invention. Preferably, each of the components of the secure computing device 300 described above includes embedded code that can be updated, most preferably via an external cable interface. This would provide a convenient method for provisioning the components based on the latest specifications.

At the heart of the secure computing device 300 is processing device (e.g., microprocessor, microcontroller, etc.) 320 and processing device support components (e.g., memory, clocking, etc.) 325, which includes the software of the invention stored therein. The software of the invention enables implementation of various security and cryptographic features, some of which are disclosed in co-pending U.S. patent application Ser. No. 12/916,535 entitled “Secure Communication System for Mobile Devices” to Jones et al., filed Oct. 30, 2010, and co-pending U.S. patent application Ser. No. 12/916,522, entitled “Technique for Bypassing an IP PBX” to Patel et al., filed Oct. 30, 2010, the contents of both of these applications incorporated herein by reference in their entirety. Such features include authentication management (including real-time ad hoc secure enclave management), group and contact management (including real-time addition/revocation), sanitization management (including rapid memory wiping), data-in-transit protection (including peer-to-peer encryption and security, “stealth” call set up techniques, no “man-in-the-middle” security, and key roll-over and related features), data-at-rest protection, data-in-use protection, seamless secure mobility management (including the ability to roam from one disparate network to another, while in secure mode, without losing crypto synch), and audit chain (including end-user capability to define chain of custody).

Notable advantages of the present invention include, without limitation, the ability to provide a mutually exclusive, independent computing environment whereby enhanced security can be offered without knowledge of the host device and the host-computing environment. Preferably, this invention allows a user to carry their security credentials with them in the secure computing device 300 independent of which host-computing device(s) 350 used such as environments where shared computing resources are found. Further, often commercial computing device manufacturers do not alter their devices to offer security to accommodate privileged data environments such as found in various environments such as medical community, financial community, defense and government communities, etc. This invention allows existing commercial devices to operate at a much higher level of protection than could be otherwise allowed on the host device.

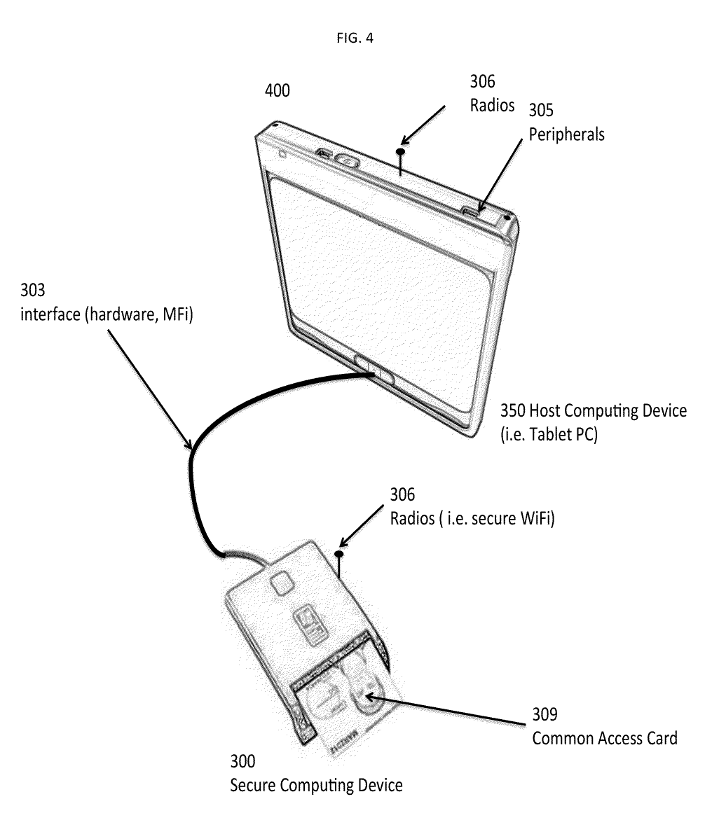

FIG. 4 shows an exemplary system 400 including the secure computing device 300. As illustrated, the secure computing device 300 can accommodate any type of host-computing device 350 including a smartphone or tablet PC. In this example, the tablet PC can connect to 802.11g (minimum) WPA2-Enterprise wireless networks using an encryption module. Advantageously, the Wi-Fi radio 306 in the secure computing device 300 can be used rather than the tablet's unsecured radio. While connected to the network via the secure computing device 300, the user can access PKI-controlled websites by using the currently inserted common access card (CAC) 309 for authentication. The website will be displayed in a web browser application on the tablet PC. With CAC integration, the secure computing device 300 can use the inserted CAC 309 card as a cryptographic ignition key, requiring a valid CAC with valid PIN or passcode to perform any encryption operations. The secure computing device 300 can store (data-at-rest) sensitive data in internal memory, protected with encryption. This data will be encrypted using the user's CAC 309 card, and only be able to be decrypted when the CAC 309 is inserted and unlocked. Because the secure computing device 300 includes auxiliary batteries, using the secure computing device 300 provides additional battery life. As constructed, the secure computing device 300 contains a modular electronics design, such that by making tradeoffs in the number of auxiliary batteries and additional weight, the secure computing device 300 can provide other data collection functionalities such as: (1) biometric enrollment/verification devices; (2) onboard cameras, permitting video recording or videoconferencing through the cryptographic module; (3) GPS antenna, with position information protected (enabling the “Geo-Spacial” features described hereinafter); and (4) additional radios, including options for tactical mesh IP, anti jam or beyond-line-of-sight communications, etc.

In addition to the features described above, the secure computing device 300 can also be configured to be limited to operate, or be prevented to operate, within a configured geographic boundary. Periodically, during operation, the device can determine its position using a position sensor (such as GPS, accelerometer, or a gyroscope) or by employing triangulation. After determining the position, a secure routine with the device can then determine if the device is geographically limited, and, if so, whether the device is within the limited area. If the device has been moved from the allowed area of operation, the routine can cause the device to be locked and refuse access, cause a panic data wipe of the device, or some other configurable function. This feature also provides the ability to dynamically provision a slow-moving or fixed surveillance asset to a contact list, permitting two-way trusted encrypted communication with the asset without requiring explicit per-instance configuration. This feature would additionally provide the ability to dynamically discover and provision other users who are using enabled communications devices offering the option to allow the end-user the ability to explicitly allow itself to be added to the secure group thus permitting two-way trusted encrypted communication.

By way of example, an encrypted IP security camera with remote control functionality is procured for a new mission. Before placement, the camera is provisioned into a secure enclave, and, furthermore it is registered with the Geolocation Service as a discoverable asset. The camera is placed in a strategic location with sufficient network bandwidth for its information payload. After placement, the camera periodically uses a built-in location device (e.g., GPS) to determine its physical location to its maximum precision. It also periodically downloads configuration data from the network. The downloaded configuration data contains parameters defining a geographical area relative to the camera's physical location. This geographical area can be defined as any two-dimensional field of points where point (0,0,0) is defined as the camera's location. Whenever the camera's physical location changes, the camera sends an encrypted geographical registration notification to the Geolocation Service containing a coarse-resolution physical location, provided by applying a mathematical rounding function to the precise location information. The level of obfuscation applied is contained within the configuration parameters. The registration notification sent by the camera also contains a coarse discovery radius, also a configurable value.

From the perspective of a mobile user, periodically or upon user-invocation the device will determine its physical location and send a coarse-resolution geographic discovery request to the Geolocation Service. The Geolocation Service will determine potential matches based on the coarse location of the mobile user and the coarse location of all registered discoverable assets and their discovery radii. The potential matches are then provided in response to the mobile user in the form of secure contacts. The mobile user device then can validate trust to each of the provided discoverable assets, and then either display discoverable assets as potential devices for the user to query at their leisure, or can automatically query each discoverable asset to determine whether it is valid for communication. Regardless of how the query begins, the mobile device sends an encrypted message to the discoverable asset through the network containing the device's high-precision location. The discoverable asset decrypts the message, validates the trust to the mobile device and then determines whether the mobile device's location is within the configured valid-location space. If the device is not within its valid space, the asset denies the query with an encrypted failure response. Otherwise, the asset responds with an encrypted access-granted notification. At this point the mobile device can set up an encrypted data session with the discoverable asset using the normal means to exchange data.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A secured computing system comprising:
a host-computing device positioned in proximity to a secure computing device and coupled with the secure computing device via a communication interface;
a processing device, integral with the secure computing device, the processing device adapted to allow communication with the host-computing device, when the host-computing device is positioned in proximity to the secure computing device;
a battery charging and power measurement circuit;
secured peripherals;
radios;
processing device support components; and
embedded code to perform security operations.

2. The system of claim 1, wherein the host-computing device is an iOS enabled device and the host platform interface is an “MFi” approved interface.

3. The system of claim 1, wherein the host-computing and secure computing device are coupled via an external hardware interface, such as a USB connection.

4. The system of claim 1, wherein the host-computing device and the secure computing device are coupled via wireless connections via the radios enabling the devices to be coupled even when the host-computing device has a proprietary external hardware interface, or no external hardware interface at all.

5. The system of claim 1, wherein the secure computing device includes multiple radios or a radio capable of channel-switching to connect simultaneously with the host-computing device and an external wireless network.

6. The system of claim 1, wherein the battery charge circuit and power management circuit provide auxiliary power to the host-computing device.

7. The system of claim 1, wherein the peripherals comprise a video camera, smart card, or biometric reader.

8. The system of claim 1, wherein the embedded code can be updated via an external interface to provision the devices based on the latest specifications.

9. The system of claim 1, wherein the processing device support components comprise memory that includes the embedded code stored therein.

10. The system of claim 1, wherein the embedded code enables real-time ad hoc secure enclave management, group and contact management including real-time addition and revocation, sanitization management including rapid memory wiping, data-in-transit protection including peer-to-peer encryption and security, stealth call set up techniques, no-man-in-the-middle security, and key roll-over and related features, data-at-rest protection, data-in-use protection, seamless secure mobility management including the ability to roam from one disparate network to another, while in secure mode, without losing crypto synch, and audit chain including end-user capability to define chain of custody.

11. The system of claim 1, wherein security credentials are carried and stored in the secure computing device's memory and independent of which host-computing device is in use.

12. The system of claim 1, wherein the host-computing device comprises a commercial-off-the-shelf device and the secured computing device enables the host-computing device to operate at a much higher level of protection than could be otherwise allowed compared to just using the commercial-off-the-shelf host-computing device.

13. The system of claim 1, wherein the secure computing device accesses PKI-controlled websites by using a common access card (CAC) for authentication as a cryptographic ignition key, requiring a valid CAC and a valid PIN or passcode to perform encryption operations.

14. The system of claim 13, wherein the secure computing device stores sensitive data in internal memory, protected with encryption enabled by use of the CAC and valid PIN, and only able to be decrypted when the CAC and valid PIN are inserted and unlocked.

15. The system of claim 1, wherein the secure computing device comprises position sensors and the embedded code is further configured to enable the secure computing device to determine the position of the host-computing device and limit operation, or prevent operation based on the host-computing device's position relative to a geographic boundary.

16. The system of claim 15, wherein the position sensor comprises a GPS, accelerometer, or gyroscope.

17. The system of claim 15, wherein after determining the position of the host-computing device, the embedded code enables the secure computing device to determine if the host-computing device is geographically limited, and if so, whether the host-computing device is within the limited geographic location.

18. The system of claim 15, wherein the embedded code is further configured to enable the secure computing device to determine if the host-computing device has been moved from the allowed area of operation and performing a configuring operation on the host-computing device.

19. The system of claim 18, wherein the configuring operation comprises changing the configuration of the host-computing device to be locked, causing a panic data wipe of the device, dynamically provisioning a slow-moving or fixed surveillance asset to a contact list, permitting two-way trusted encrypted communication with the asset without requiring explicit per-instance configuration, or dynamically discovering and provisioning other host-computing devices by offering the option to allow the end-users of the host-computing devices the ability to allow itself to be added to the secure group thus enabling two-way trusted encrypted communication at the edge.

20. A non-transitory computer-readable medium which stores a set of instructions which when executed performs a method for providing secure communication, comprising:
enabling the secure computing device to utilize position sensors to determine the position of the host-computing device;
enabling the secure computing device to determine if the host-computing device's authority to operate is limited based on a geographic location;
enabling the secure computing device to determine if the host-computing device has been moved outside the limited geographic location and, if so, performing a configuring operation on the host-computing device; and
wherein the configuring operation comprises changing the configuration of the host-computing device to be locked, causing a panic data wipe of the device, dynamically provisioning a slow-moving or fixed surveillance asset to a contact list, permitting two-way trusted encrypted communication with the asset without requiring explicit per-instance configuration, or dynamically discovering and provisioning other host-computing devices by offering the option to allow the end-users of the host-computing devices the ability to allow itself to be added to the secure group thus enabling two-way trusted encrypted communication at the edge.
